(19) United States
(12) Patent Application Publication
(10) Pub. No.: US 2020/0130870 A1
(43) Pub. Date: Apr. 30, 2020

(54) Alcubierre - White Warp Drive Machine

(71) Applicants: Eytan Halm Suchard, Chicago, IL (US); Jessica Lynne Gallanis, Chicago, IL (US)

(72) Inventors: Eytan Halm Suchard, Chicago, IL (US); Jessica Lynne Gallanis, Chicago, IL (US)

(21) Appl. No.: 16/177,167

(22) Filed: Oct. 31, 2018

(51) Int. Cl. B64G 1/40; H01F 7/20

(52) U.S. Cl. CPC B64G 1/409; H01F 7/204

(57) ABSTRACT

In one aspect, the present invention is directed to a method of generating negative and positive gravity within thin walls that enclose a spacecraft's space or cavity, possibly with passengers. One wall generates weak negative Ricci curvature and another wall generates weak positive Ricci curvature in their centers. The machine achieves this by electric charge separation within at least two capacitors; each capacitor consists of two or more thin conducting layers and of one or more dielectric layers. In the case of 3 conducting layers, the rear capacitor's conducting middle layer is charged with negative charge while the front capacitor middle layer is charged with positive charge. In absolute value, the middle layers may have more charge than the sum of charge in the layers around them. In another embodiment of the invention, at least one of the capacitor layers in each one of the two capacitors is replaced by a rotating conducting curved plate or with a thin curved drum shaped coil in which electric current flows, in order to generate a dynamic component of the electric field. By using the capacitors alone, the Machine generates a very weak warp drive with negative and positive gravity which can be as low as 18 orders of magnitude less than required by an Alcubierre warp drive's classical (+, −)10²⁷ Kg. In that aspect of the invention alone without a dynamic field, the machine will not manifest any measurable propulsion. In another aspect, the layers are provided with a dynamically changing electric field that in addition to the static baseline of their electric field, the rapidly changing dynamic electric field is in high radio frequency or is in lower frequency but with high spike wave form. By the Harold White effect, this dynamic field dramatically reduces the amount of gravity and antigravity which are required in order to achieve feasible propulsion for space travel. In another aspect of the invention, the space between the two capacitors is enclosed by this dynamic field, which provides inertial shielding of the craft. The invention is aimed at harnessing gravity and antigravity which are generated by electric charges, and which are not part of the gravity expected from the Electromagnetic Energy Momentum Tensor in the Theory of General Relativity.

The present application claims the benefit of U.S. Provisional Application No. 62/610,804, filed on Dec. 27, 2017, and incorporated herein by reference.

### FIELD OF THE INVENTION

The present invention relates to the field of propulsion by changing the metric tensor of space-time via manipulation of electric charges and of electric fields. In its more general aspect, the field of the invention does not require the use of electromagnetism. It has three main categories, Alcubierre Warp Drive, Alcubierre Froning Warp Drive and Alcubierre White Warp Drive. The Alcubierre Warp Drive (Alcubierre, M., “The warp drive: hyper-fast travel within general relativity,” Class. Quant. Gray. 11, L73-L77 (1994)) requires enormous amount of anti-gravity and of gravity to achieve faster-than-light/superluminal space travel, has other problems and is therefore too theoretical. Froning offers a way to reduce the resistance of space-time to acceleration (H. D. Froning Jr. , “Fast space travel by vacuum zero-point field perturbations”, Mar. 27, 2008, AIP Conference Proceedings 458, 920 (1999); https://doi.org/10.1063/1.57491) . Alcubierre—White is another form of warp drive that softens space-time by rapidly oscillating energy and by using a ring structure of an oscillating mass, e.g. electric fields (see, Warp Field Mechanics 101, Dr. Harold “Sonny” White NASA Johnson Space Center 2101 NASA Parkway, MC EP4 Houston, Tex. 77058 https://ntrs.nasa.gov/archive/nasa/casi.ntrs.nasa.gov/20110015936.pdf). White's paper also includes methods to measure the occurrence of warp drive.

### BACKGROUND OF THE INVENTION

The background of the invention is known as Warp Drive, specifically known as three main ways to modify space-time in order to allow faster than light/superluminal space travel. The first is Alcubierre metric (Alcubierre, M., “The warp drive: hyper-fast travel within general relativity,” Class. Quant. Gray. 11, L73-L77 (1994)., second is Alcubierre—Froning metric (H. D. Froning Jr. , “Fast space travel by vacuum zero-point field perturbations”, Mar. 27, 2008, AIP Conference Proceedings 458, 920 (1999); https://doi.org/10.1063/1.57491) and the third is Alcubierre-White metric (see, Warp Field Mechanics 101, Dr. Harold “Sonny” White NASA Johnson Space Center 2101 NASA Parkway, MC EP4 Houston, Tex. 77058 https://ntrs.nasa.gov/archive/nasa/casi.ntrs.nasa.gov/20110015936.pdf). In 1994, Miguel Alcubierre, a Mexican mathematician, published a revolutionary paper in the journal Classical and Quantum Gravity about a very special solution to the Einstein—Grossmann equations of gravity in Einstein's General Theory of Relativity. Unlike the ordinary way of solving Einstein's tensor equations, by first setting the matter configuration and only then by calculating the space-time metric, Alcubierre started from the metric and then later showed that for that metric, both positive and negative gravity sources are required as negative and positive Ricci curvature (the volume elements of curvature contrasted by the Weyl components of the Riemann tensor). The previous solutions to Einstein's equation of gravity started with the matter configuration as can be seen throughout history as in the case of Karl Schwarzschild first solution to Einstein equations in 1915 or as in Friedmann-Lemaître-Robertson-Walker (FLRW) metric of the cosmos (1920-1930), or as with Roy Patrick Kerr solution to the metric of a rotating black hole from 1963. The Alcubierre solution suggested a method for changing the metric of space-time and creating a space-time warp bubble such that while from outside the bubble, the bubble can advance in superluminal speed, from within the bubble the speed is much lower than the speed of light. This is achieved by two gravitational walls. The rear wall of the bubble has a negative gravity in its middle that rapidly decays out of the wall. The decay is outwards of the Alcubierre warp drive bubble and into the bubble. The front wall of the bubble has a positive gravity in its middle that rapidly decays out of the wall, out of the bubble and into the bubble.

Alcubierre metric appears in a foliation (slices of space-time) form as ds²=(1−β²)dt²+2βdxdt−dx² where β is a function of the warp's shape and of the warp's velocity. X stands for the x coordinate and t designates the time coordinate. The term 2βdxdt has the opposite sign of −dx² and can be made to cancel out the distance. In other words, from within the warp, distances become shorter. The term “ds” stands for distance between near events in space—time as a differential of proper time and the equation is called the Alcubierre “metric of space-time”. This metric of space-time represents the measurement of time from within the bubble.

Many attempts at achieving a link between gravity and electromagnetism have been taking place in the world. An experiment with interesting results is the one of Takaaki Musha, based on empirical test of suspended capacitor in oil in order to avoid ionic wind, see: INTERNATIONAL ACADEMY OF ASTRONAUTICS Missions to the outer solar system and beyond FIFTH IAA SYMPOSIUM ON REALISTIC NEAR-TERM ADVANCED SCIENTIFIC SPACE MISSIONS Aosta, Italy, Jul. 2-4, 2007, “Explanation of dynamical Biefeld-Brown Effect from the standpoint of ZPF field”, Pages, 4, 5, 6.

Another important work includes a force on a suspended metallic ball in a high gradient dynamically changing electric field, such that the force unexpectedly depends on the mass of the ball. This experiment was performed by Timir Datta et. Al. (T. Datta, Ming Yin, Andreea Dimofte, M. C. Bleiweiss, Zhihua Cai, “Experimental Indications of Electro-Gravity” https://arxiv.org/abs/physics/0509068 , 8 Sep. 2005).

A relatively new theoretical progress was published by Eytan Suchard, (See arXiv1806.05244v8, https://arxiv.org/abs/1806.05244v8 and an lOPScience DOI: 10.1088/1742-6596/845/1/012019 see the divergence term in (34) Page 22, also found in http://iopscience.iop.org/article/10.108⁸/₁742-6596/845/1/012019). The arXiv version 1806.05244v8 predicts the mass of the electron out of the mass of the Muon with an accuracy of 3/10,000,000,000 based on electro-gravity calculations of gravity and of antigravity. It also assesses the Fine Structure constant with an error less than 1/27000 of the value and can do even better if (B.32.2) is used instead of the approximation (B.32.3) and (B.33.1) instead of the approximation (B.33), pages 40, 41.

An active private research is done by Space Warp Dynamics LLC, (http://www.spacewarpdynamicsllc.com). Space Warp Dynamic, however, fails to disclose the use of two walls, made of three conducting layers as capacitors, as disclosed in the current invention. Space Warp Dynamics devices generate a geometrically asymmetrical oscillating electric field. Space Warp Dynamics also induce a tri-pole by using antennas (Space Warp Dynamics Indiegogo Video) but without any charge separation that involves electrons or charged particles or layers as disclosed in the current invention.

### SUMMARY OF THE INVENTION

The invention uses two Alcubierre gravitational walls to achieve a warp drive effect as means of propulsion while surrounding or enclosing a cavity or space where passengers can travel. Unlike in Miguel Alcubirre's Warp Drive, only in one embodiment of the invention, the requirement for fully positive and fully negative gravity walls is obeyed. The reason is that fulfillment of the warp drive as is, generates a high electric field within the spaceship, which is not preferable and dangerous to human lives. A broader approach than that of Alcubierre is adopted in several other embodiments of the invention in which anti-gravity and gravity walls need not strictly dictate negative trace of Alcubierre's Extrinsic Tensor and Positive trace of Alcubierre's Extrinsic tensor (Miguel Alcubierre, “The warp drive: hyper-fast travel within general relativity”, Sep. 5, 2000, arXiv:gr-qc/0009013v1, equation (12)). One of the walls, hereafter referred to as the Rear Wall, generates weak antigravity and the other, hereafter referred to as the Front Wall, generates weak gravity. The rear wall can be implemented as a two conducting layers capacitor or as a three conducting layers and can be named, “rear tri-pole” capacitor, “rear gravitational wall”, “rear Alcubierre wall” , “rear gravitational Alcubierre wall” , “rear Alcubierre gravitational wall”, “anti-gravity wall” or “rear wall”. The other wall, hereafter referred to as the Front Wall, can be implemented as two conducting layers or plates capacitor or as three conducting layers or plates capacitor and can be referred to as “front tri-pole capacitor”, “front gravitational wall”, “front gravitational Alcubierre wall”, “front Alcubierre gravitational wall”, “gravity wall” or “front wall”. There is also a difference between the gravity generated by the middle layer of the front wall and the gravity generated by the external layers of the rear wall, or by the two layers of the rear wall and by the two layers of the front wall when two conducting layers constitute the rear wall and when two conducting layers constitute the front wall.

The following refers to the implementation when the rear wall consists of three conducting layers and two dielectric layers and the front wall consists of three conducting layers and two dielectric layers. The positive charge on the middle layer of the front wall should be higher than the sum of charge on the external layers of the rear wall. In absolute value, the negative charge on the middle layer of the rear wall should be higher than the sum of negative charge on external layers of the front wall. This requirement is optional because the invention need not fully comply with the sign of the volume expansion/contraction of Alcubierre's metric (Miguel Alcubierre, “The warp drive: hyper-fast travel within general relativity”, Sep. 5, 2000, arXiv:gr-qc/0009013v1, equation (12)).

In addition, the invention generates a dynamically changing gravitational field in these two walls, rear wall and front wall. This dynamically changing field dramatically reduces the amount of anti-gravity and of gravity, which is required to generate a feasible warp drive for the purpose of space propulsion. It also softens the non-compliant space-time metric volume elements when the front wall contains also negative charge in its external layers and when the rear wall contains also positive charge in its external layers. In another embodiment of the invention, the front wall is made of two conducting layers and a dielectric material between them and so is the rear wall. In this case, the Direct Current, DC component of the voltage of front wall is positive for both conducting layers and the DC component of the rear wall voltage is negative in both conducting layers.

In the one embodiment, the rear wall is made of 5 layers which constitute a 120 degrees dome shaped tri-pole capacitor though other shapes may be used. The middle layer is an electric conductor that is preferably made of silver and is charged with negative charge. It is a thin layer of about 10 micro-meters and therefore cannot withstand high currents. The charge on this layer should have a stationary baseline of about −0.247 Coulombs per square meters but can have a dynamic component too. Around the middle layer there are two layers of a dielectric material that can withstand at least 5000 volts over 10 micro-meters, which is their thickness. In the preferred embodiment, this material is Tantalum Pentoxide Ta2O5 and it can withstand a breakdown voltage of 625 volts over 1 micro meters. Around these two dielectric layers there are two electric conductor layers thicker than the middle layer such that these layers can withstand tens of Amperes of electric current and a dissipation of thousands of Watts per square meters. Preferably these two layers are referred to as “external layers” and should be at least 1 mm thick in order to withstand high electric current peaks. The external layers of the rear wall are charged with positive charge and can be made of copper or silver. The middle layer is charged with at least −0.247 negative Coulombs per square meter and then the external layers are charged with at least +0.1235 Coulombs per square meter each.

The external layers of the rear wall are also fed with high frequency alternating current of low voltage that can be lower than 12 volts. Recommended frequency is from several mega Hertz to 30 Giga Hertz, unless a high spike wave—form is used, limited to 500 Volts from its bottom to its peak. A high time gradient wave form can reduce the frequency requirement by 3 orders of magnitude though the reason for this effect as seen in experiments by Timir Datta ((T. Datta, Ming Yin, Andreea Dimofte, M. C. Bleiweiss, Zhihua Cai, “Experimental Indications of Electro-Gravity” https://arxiv.org/abs/physics/0509068 , 8 Sep. 2005)) and by Takaaki Musha (INTERNATIONAL ACADEMY OF ASTRONAUTICS Missions to the outer solar system and beyond FIFTH IAA SYMPOSIUM ON REALISTIC NEAR-TERM ADVANCED SCIENTIFIC SPACE MISSIONS Aosta, Italy, Jul. 2-4, 2007, “Explanation of dynamical Biefeld-Brown Effect from the standpoint of ZPF field”, Pages, 4, 5, 6.) is not totally understood. In both cases step waves were used with very steep gradient walls.

The front wall is made of the same materials as the rear wall but the middle layer is charged with a baseline of at least +0.247 coulombs of positive charge per square meters of area. The external layers are charged −0.1235 Coulombs per square meter each.

The external layers of the front wall are also fed with a high frequency alternating current just as the rear wall or with a lower frequency spike wave—form just as the rear wall's external layers are fed with a dynamic component of voltage. A small variation of the connections is that the wiring of the rear wall and of the front wall can be done from the space between the walls through electrically isolated holes in the middle of the rear wall and in the middle of the front wall vertical to the layer surfaces. Such a wiring is preferable at high frequencies that are fed to the external layers of the rear and of the front walls. This is true because at high frequencies, it is beneficial to generate standing waves on the external layers that oscillate the amount of charge in different areas of the external layers. The standing waves can be in resonance which amplifies the oscillations.

The gravitational field generated by charge can be described by various models. An example is the use of a Reeb vector, (Reeb 1948) in Suchard's paper,

$$\frac{1}{4} ( {U}_{μ} {U}_{v} = \frac{1}{2} {U}_{k} {U}^{k} {g}_{μ v} - 2 {U}^{k} ; k \frac{{P}_{μ} {P}_{v}}{Z} ) = {R}_{μ v} - \frac{1}{2} {Rg}_{μ v}$$

$$Z = {P}_{η} {P}^{η}$$

This equation appears on page 22 as term (34) and is the real numbers format of equations that result from the Calculus of Variations. See http://iopscience.iop.org/article/10.1088/1742-6596/845/1/012019. A more advanced paper can be seen in arXiv1806.05244v8, https://arxiv.org/abs/1806.05244v8. The term U^{k};ₖ means charge density up to multiplication by a constant, which can be either negative or positive. U_{μ} denotes a Reeb vector. R_{μν}−1/2 Rg_{μν} is Einstein's tensor. 1 Coulomb of charge generates gravity of about 5.8023 billion kilograms but properties which do not match inertial mass as it depends on a unit vector that is not necessarily aligned with the motion of the charge. The charge to mass equivalence is in this formula:

$${M}_{Charge \text{-} Gravitational \text{-} Mass} = \frac{\pm Q}{\sqrt{16 π K {ɛ}_{0}}}$$

Where K is Newton's gravity. Epsilon 0 is the permittivity of space. Q is the charge and negative charge generates negative gravity along with much smaller gravity by its rest mass.

The exact formula for space-time metric of the Alcubierre—White solution is not so important, regarding the amount of anti-gravity and of gravity that are needed as Harold White's assertions imply that less than one Billion Kilograms of negative and positive mass are sufficient in order to achieve superluminal propulsion by contracting the x axis metric from within the Alcubierre—White warp and the current invention requires −0.247×2 Coulombs, 0.247 in the rear wall's middle layer and −0.247 in the front wall's external layers per square meter. In fact, Harold White's solution does not require negative mass. The total negative charge, on the two tri-pole capacitors that constitute the rear wall and the front wall, generates a gravitational effect of more than 2 billion Kg of negative mass per square meter wall area per each wall. In fact there are papers that assert that even about 700 Kg of negative mass are sufficient, see, Moskowitz, Clara (17 Sep. 2012). “Warp Drive May Be More Feasible Than Thought, Scientists Say”. Space.com. Archived from the original on 13 Jan. 2013. Retrieved 10 Jan. 2013. This means that another implementation with a rear wall of only negative charge and with a front wall of only positive charge is also a feasible implementation and has the advantage of being more compliant with the combination between Suchard's theory and Alcubierre's warp drive.

In an addition to the invention in the first embodiment, the external layers or the middle layer of the rear wall and the external layers or the middle layer of the front wall are split vertically into gapped sectors in order to allow the steering of the spaceship that is propelled by the invention. In this case, at least the external layers are divided into sectors and each one of the sectors receives different voltage in order to allow different antigravity and different gravity intensities.

In another embodiment of the invention, the rear wall has two conducting layers and the front wall has two conducting layers. The front wall's two conducting layers are fed with a positive Direct Current DC component of their voltage through a middle bifurcation of a coil. Likewise, the rear wall's layers are fed with a negative DC component of their voltage. The DC voltage is hundreds of thousand s of volts. The Alternating Current component of the rear wall is fed through a coil and the alternating current component of the front wall is fed though a coil.

In addition, the top layer of the rear wall and the bottom layer of the front wall can optionally rotate one clockwise and one anticlockwise. The dynamic field, either by oscillation or by rotation, is meant to soften space-time resistance to the warp and thus reduce the amount of gravity and antigravity that are required to generate the warp.

### BRIEF DESCRIPTION OF THE DRAWINGS

FIG. 1 describes an Alcubierre—White warp dive engine. The middle layer of the rear wall is fed with a negative baseline of −2500 volts. The external layers of the rear wall are fed with a baseline of +2500 volts each and in addition they are fed with an alternating current/voltage from two different bifurcated coils of the same transformer. The size of the transformer is not more than 20 cm×20 cm×20 cm, unlike in the drawing where the scaling factor of the transformer is higher than that of the rear wall and of the front wall. The frequency of the alternating current can vary between several mega Hertz to 30 Giga Hertz and the power of the oscillator should be up to several kilowatts. The distance between the middle layer and the external layers of both the rear wall and of the front wall is 10 micro meters, which is also the thickness of the Ta2O5 dielectric layers and is also the thickness of the middle layer in both the rear wall and in the front wall. The radius of the 120 degrees domes, i.e. rear wall and front wall is several meters.

The final optional feature is that the amount of positive charge on the middle layer of the front wall is higher than the amount of positive charge on the external layers of the rear wall. Also, the amount of negative charge on the middle layer of the rear wall is higher than the amount of negative charge on the external layers of the front wall. A potential difference between the middle layer of the front wall and the middle layer of the rear wall which is above 1000 volts requires more than 20 micro meters thickness of Ta2O5 that separates between the middle layers and the external layers.

FIG. 2 implements the rear Alcubierre wall, or rear wall, by two conducting layers/plates, referred to as bottom layer of the rear wall and by a top layer of the rear wall. The rear wall is thus a capacitor. The Direct Current that is fed to these layers or plates that constitute the rear wall is fed through a middle bifurcation of a coil and is negative. The front Alcubierre wall, or front wall, is also made of two conducting layers that constitute a capacitor. They are referred to as the bottom layer of the front wall and as the top layer of the front wall. The Direct Current that is fed to these layers or plates that constitute the front wall is fed through a middle bifurcation of a coil and is positive.

The charge on the bottom layer of the rear wall and on the top layer of the rear wall, oscillates between these two layers due to the alternating current that is fed to these layers through a coil. The charge on the bottom layer of the front wall and on the top layer of the front wall oscillates between these two layers due to the alternating current that is fed to these layers through a coil.

The upper layer of the rear wall and the bottom layer of the front wall optionally rotate one clockwise and one anticlockwise. The oscillations and rotations are meant to create a dynamic gravitational field and thus to reduce the amount of gravity and of antigravity that are required to warp space-time. This implementation is recommended as the first implementation of the invention because it is easier than the other embodiments and more compliant with the Alcubierre warp drive.

FIG. 3 describes the rear wall and the front wall when they are split into 4 sectors each. Each sector's external layer is fed with a different voltage baseline. This allows the steering of the spaceship which is propelled by the invention. The number of sectors can vary and should be more than two for the rear wall and more than two for the front wall.

### DETAILED DESCRIPTION OF THE INVENTION

In the following description of the invention different specifications are set forth. These specifications are obvious to the ones skilled in the art and therefore, for the sake of brevity, the obvious details are shortly described.

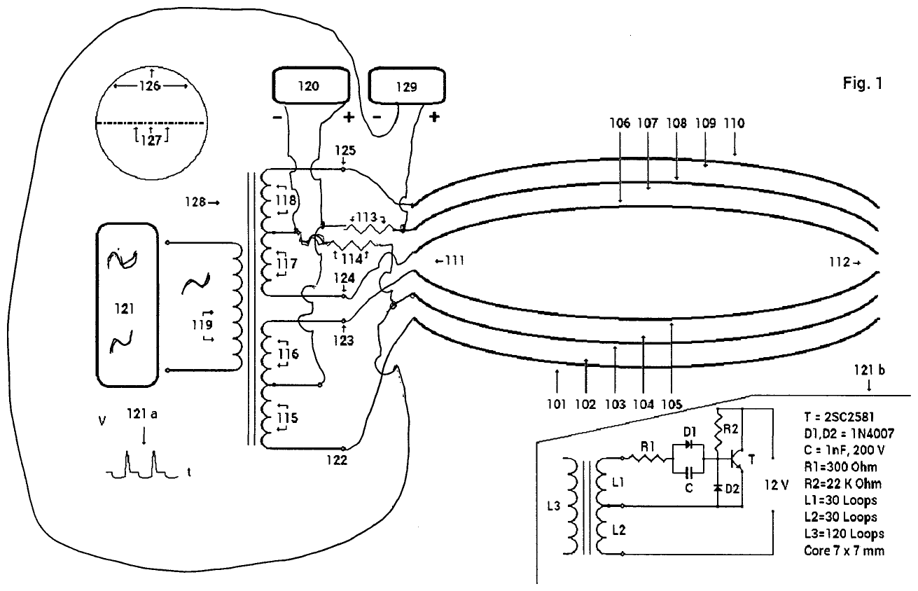

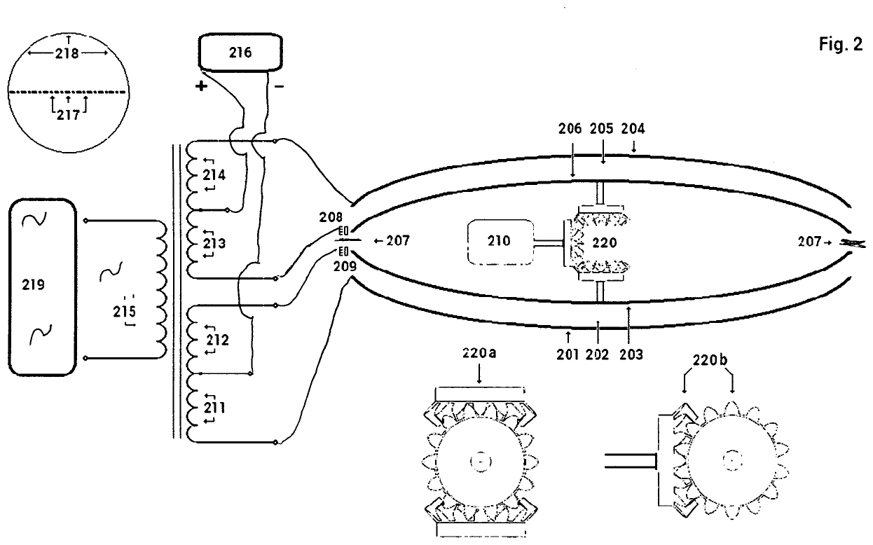

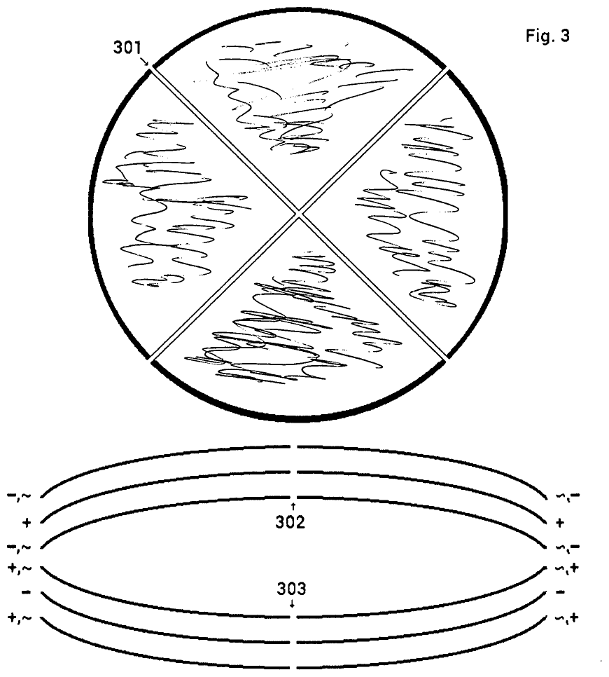

In FIG. 1. Two tri-pole capacitors are used. The term tri-pole refers to a capacitor that is made of at least 5 layers or interchangeably 3 plates when regarding electrically conducting layers. Items 101 and 105 are the external layers or plates of such a capacitor. Item 103 is the middle layer or plate of the same capacitor. Items 102 and 104 refer to the dielectric layers of the capacitor. The dielectric layers 102,104 fill the space between the external layers 101, 105 and the middle layer 103. The thickness of layer 103 is 10 micro-meters, the thickness of layers 102 and 104 is 10 micro meters. The thickness of the external layers 101, 105 is about 1 mm. Layers 101, 102, 103, 104, 105 constitute a tri-pole capacitor and will be referred to as “rear wall” or “rear Alcubierre wall”. For space travel applications these sizes may greatly vary. For example, the middle layer 103 can be 1 mm thick and the dielectric layers 102, 104 may be several cm thick though it is preferable to have a thin middle layer and thin dielectric layers. Quite in the same manner, layers 106, 107, 108, 109, 110 form a tri-pole capacitor. Layers 106, 110 are referred to as external layers or external plates. Layer 108 is referred to as middle layer or middle plate. Layers 107 and 109 are referred to as dielectric layers. Layers 106, 107, 108, 109, 110 are called, “front wall” or “front Alcubierre wall”. Layer 103 can also be named the middle layer or the middle plate of the rear wall. Layers 101 and 105 can also be called the external layers or external plates of the rear wall. In the same manner, layer 108 is referred to as the middle layer of the front wall. Layers 106 and 110 are referred to as the external layers of the front wall.

In this embodiment, the layers form a 120 degrees dome of a radius of several meters. From above, Layers 101, 102, 103, 104, 105 form a concave dome and layers 106, 107, 108, 109, 110 form a convex dome. These two domes enclose a cavity between layers 105 and 106. It is very important that this cavity will be as closed as possible by layers 101 and 110 in order to achieve the inertial shielding which is required by the White—Alcubierre warp drive. Failing to do so may result in the loss of the warp bubble.

Layer 103 is connected via resistor 114 of several mega Ohms (up to tens of mega Ohms) to −2500 volts. See the Direct Current—DC source 120. Layers 101 and 105 are connected to +2500 volts from the same DC source 120, via coils 115 and 116 of a ferrite, or of another material, core transformer that can transfer several kilowatts of power at radio frequency, several mega Hertz to 30 Giga Hertz of alternating current. Layer 103 can alternatively be connected to resistor 114 by brush contacts and can be rotated by some mechanical means in order to generate a rotational dynamic field as this is another way to achieve a dynamic field. Such an option will be detailed in drawing 2 in another embodiment of the invention.

An alternative is to use low frequency, as low as 100 K Hz but to use a high spike waveform as seen in graph 121a and a typical circuit for such a waveform is 121 b. The wave amplitude i.e. maximal voltage minus its lowest voltage should not exceed 500 Volts. The output of this circuit 121 b, is from the coil that does not have a middle bifurcation. The reason for this reduction in frequency requirement of about 3 orders of magnitude is not fully understood and was observed in experiments such as of Timir Datta and of Takaaki Musha who used only low frequency and a square wave with steep walls. Both researchers were mentioned in the background of the invention. In that case, if the waveform is asymmetrical, the positive side/polarity of the spike, i.e. the maximal voltage of the wave is fed/received by the external layer above the middle layer and the negative side/polarity is fed/received by the external layer of below the middle layer for both the rear wall and the front wall. The terms “below” and “under” do not limit the orientation of the machine. When these terms are used, the Rear Wall is below the Front Wall or the Front Wall is above the Rear Wall.

Layer 108 is connected via resistor 113 of several mega Ohms (up to seal tens of mega Ohms) to +2500 volts. See the DC source 120. The external layers of the front wall, layers 106 and 110 are connected to −2500 volts via coils 117 and 118 to the negative output of DC source 120. To avoid a short, layers 105 and 106 are electrically isolated from each other by insulators 111 and 112 that from above look like a flat rim. Coil 119 is wound around the same transformer core as coils 115, 116, 117, 118. In addition to the baseline of +2500 volts, layers 101 and 105 are fed with AC via connection points 122 and 123. In addition to the baseline of −2500 volts, layers 106 and 110 are fed with AC via connection points 124 and 125. Coils 115,116,117,118 are wound in the same direction and have the same number of windings. Coils 115 and 116 are isolated form coils 117 and 118. Coils 115,116,117,118,119 are designed to transfer several kilowatts of power in a certain frequency between several mega Hertz to 30 Giga Hertz. The AC power source is item 121.

126 is a top view of the circular shape of the invention that is seen from above. 127 is the symmetry line cut along which layers 101, 102, . . . 110 are viewed in the lower part of FIG. 1. Item 128 is the casing of the transformer. 129 is an optional pulsed voltage supply that is responsible that the middle layer of the front wall will be more positive than the external layers of the rear wall. This voltage supply is designed to promise a curvature volume component difference between the Front Wall and the Rear Wall.

While in the preferred embodiment the charge on layer 103 is −0.247 Coulombs per square meters and the charge on layer 108 is +0.247 Coulombs per square meters, it is desirable to achieve as high as 90,000 Coulombs per square meters in order to allow superluminal space travel. An amount of 90000 coulombs is less than the amount of negative charge in 1 gram of hydrogen. The negative charge on the middle layer of the rear wall, layer, 103, is expected to cause a weak anti-gravity field. This field rapidly decays towards the external layers 101 and 105 and out of the external layers of the rear wall, layers 101 and 105. The negative charge is expected to generate anti-gravity which is not anticipated by the theory of General Relativity, however the field is very weak, for example, but not limited to, by applying the formula

$${M}_{Charge \text{-} Gravitational \text{-} Mass} = \frac{\pm Q}{\sqrt{16 π K {ɛ}_{0}}} to - 0.247 Coulombs ,$$

the negative mass equivalent is −1.433×10\hat{ }9 Kg, about a 1.4 billion kilograms. Due to the dielectric layers, 102 and 104, the dipoles within these layers cause warp effects that cancel out. The net warping effect of space-time remains of negative space-time curvature, i.e. expansion that decays outwards of layer 103.

Layer 108 is positively charged and quite in the same manner, using the example formula, it generates a gravitational effect equivalent to +1.433×10\hat{ }9 Kg. Quite in the similar manner of description of the rear wall. The effect decays out of layer 108. The resulting order of magnitude of anti-gravity by layer 103 and gravity by layer 108 is 18 orders of magnitude less than required by the Alcubierre warp drive that surrounds or encloses a space or cavity possibly though not limited to, with passengers that travel in space. That means that static electric fields alone, will not generate any measurable thrust if the device is held in place by a suspension rod connected to the ground. That is the reason why the dynamic Harold White effect is crucial even though the ring shaped Harold White warp is not offered in this embodiment. The job of coils 115, 116, 117, 118 is to provide an alternating field to the external layers 101, 105, 106, 110 in order to soften the space time resistance to the static warp. The entire device in FIG. 1 is designed to use the Harold White effect to manifest thrust upwards when held on the ground. −0.247 and +0.247 Coulombs may not be sufficient for propulsion on the ground but according to other indications 1 milli-Newtons thrust from the experiments of David Pares from Space Warp Dynamics and from the experiments of Takaaki Musha, several Newtons are not farfetched and are already sufficient for satellite propulsion.

The existing inventions did not take into account that it is actually the divergence and not the gradient of the electric field that generates antigravity and gravity. That is one of the reasons that the current invention has an advantage over existing devices.

FIG. 2 is an implementation of the invention which is fully compliant with both Alcubierre Warp Drive and with the outcome of theories that predict unexpected anti-gravity by negative charge and gravity by positive charge beyond General Relativity. FIGS. 2, 201 and 203 are conducting layers that constitute the rear Alcubierre wall. This wall has no middle layer. Both layers receive the negative DC component of their field from the DC supply 216 via coils 211, 212. Power supply 216 in this implementation provides hundreds of thousands of volts. FIG. 2. 204, 206 are conducting layers that constitute the front Alcubierre wall. They receive the DC component of their power supply from 216 via coils 213, 214. Space 202, of the rear wall and 205 of the front wall can be replaced with a dielectric material.

The top layer of the rear wall and the bottom layer of the front wall are optionally connected to a beveled gear 220 and rotated, top layer of the rear wall clockwise and bottom layer of the front wall anti-clockwise or vice versa. View from the motor 210 side of the beveled gear is in 620a and from the top it is 220b. The rotation causes a dynamic field that reduces the antigravity and gravity that are required in order to generate a space-time warp.

Coil 215 is fed by oscillator 219 and the power supply is expected to be of several kilowatts per layers 201,203, 204, 206 of a radius of several meters. The frequency can be of several Giga Hertz with low current or of lower frequency of down to several kilo hertz but with high voltage peaks and preferably not a sinus shaped voltage waveform. The alternating current AC is fed via coils 211 and 212 to the rear wall and coils 213, 214 to the front wall. The idea of this oscillation is to soften space-time and to reduce the gravity and antigravity which is required in order to generate the space-time warp. FIG. 2. 218 is a top view of the device. 217 is a symmetry cut through which layers 201,202,203,204,205 and 206 are displayed. This implementation is recommended as it is easy to implement and is compliant with an Alcubierre—White warp drive except for the ring shaped warp that Harold White has suggested. It is also important to say that instead of the gaps 202, 205, optionally dielectric material can be placed. The cavities 202 and 205 can be made of a gap, a dielectric material and a gap each. The idea is that such a configuration allows high voltage oscillations between the layers of the rear wall and high voltage oscillations of the voltage between the layers of the front wall.

FIG. 3 shows gaps between 4 sectors of the external layers. These sectors receive their input voltage like in FIG. 1 but from different sources. The vertical gaps are seen as items 301, 302, 303. The gaps are filled with an electrically insulating material such as Mica. The number 4 is not limiting. Another number of sectors greater than 2 can be implemented. Steering occurs when different voltage is applied to the different sectors of the rear wall and of the front wall. There are many ways to provide different voltage as means of steering and they usually involve the use of digital to analog micro-processors as known to experts in the prior art.

What is claimed is:

1. A machine that is designed to change the metric of space-time and to generate an Alcubierre Warp Drive or a Warp Drive bubble, by two types of walls that surround a cavity of space, where one wall, named “Rear Wall”, consists of three layers of polarity +, −, + such that the negatively charged layer, named “Middle Layer” or the Middle Layer of the Rear Wall can have at least the negative of the sum of charge in the other two layers, i.e. +Q, −2Q-Delta, +Q where Q means charge and delta means an additional negative charge or zero.

2. A machine as in claim 1 where one wall, named “Front Wall”, consists of three layers of polarity −, +, − such that the positively charged layer, named “Middle Layer” or the Middle Layer of the Front Wall can have at least the positive amount of the sum of negative charge in the other two layers, i.e. −Q, +2Q+Delta, −Q where Q means charge and Delta means an additional positive charge or zero.

3. The machine as described in claim 2 such that the external layers of the front wall and the external layers of the rear wall have an oscillating charge component.

4. A machine that is designed to generate a warp drive that uses four conducting plates or layers such that the rear wall is made of two conducting layers and the front wall is made of two conducting layers and such that the two layers of the rear wall are fed with a negative DC component and the two layers of the front wall are fed with a positive DC component and such that the charge on the two layers of the rear wall oscillates between the two layers of the rear wall and such that the charge on the two layers of the front wall oscillates between the two layers of the front wall.

5. A machine as described in claim 4, such that at least one of the conducting layers of the rear wall rotates clockwise and one of the conducting layers of the front wall rotates anticlockwise or vice versa.

6. A machine as in claim 4 or 5 such that the charge on the two conducting layers of the rear wall oscillates by AC which is supplied through a coil and such that the middle bifurcation of the coil is connected to the negative polarity of a DC source.

7. A machine is in claim 6 such that the charge on the two conducting layers of the front wall oscillates by AC which is supplied through a coil and such that the middle bifurcation of the coil is connected to the positive polarity of the DC source.

8. A machine as described in claim 3, 4 or 7 such that either the front wall or the rear walls are split and receive different voltage baseline in order to allow the stirring of the machine.
